(19) United States
(12) Patent Application Publication
(10) Pub. No.: US 2008/0066066 A1
(43) Pub. Date: Mar. 13, 2008

(54) Task queue suitable for processing systems that use multiple processing units and shared memory

(76) Inventor: Michael B. MacPherson, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/518,296

(22) Filed: Sep. 8, 2006

(51) Int. Cl. G06F 9/46

(52) U.S. Cl. 718/100

(57) ABSTRACT

A processing system includes a task queue to serve as a circular buffer. Each record in the queue may include a status field and a task field. A producer thread in the processing system may determine whether the queue is full, based on the status field in the record at the tail of the queue. The producer may add a task to the queue in response to determining that the status field in the record at the tail of the queue marks that record as empty. A consumer thread may determine whether the queue is empty, based on the status field in the record at the head of the queue. The consumer may execute a pending task identified by the record at the head of the queue, in response to determining that the status field in the head record marks that record as full. Other embodiments are described and claimed.

### FIELD OF THE INVENTION

The present disclosure relates generally to the field of data processing, and more particularly to methods and related apparatus to support task queues suitable for processing systems that use multiple processing units and shared memory.

### BACKGROUND

A processing system may include random access memory (RAM) and multiple processing units. The processing units may share some or all of the RAM. Parallel programming may be used to take advantage of multiple processing units in a processing system.

Task queues are a key mechanism used for parallel programming. A task queue is essentially a first in, first out (FIFO) data structure, into which certain threads (producers) insert items and other threads (consumers) remove items. Specifically, the producers insert items representing tasks into the task queue, and the consumers are responsible for executing those tasks and removing their items from the task queue. The items in the task queue may be referred to as entries or records, for instance.

Task queues enable parallel execution of the task creation code and the task execution code. The task queue also decouples the producer and consumer threads, so that they can run efficiently without stalling, even if the rate of task production and consumption don't always match.

A task queue may be implemented as a circular buffer. Typically, before an entry is inserted into a circular buffer, the program doing the inserting needs to ensure that the buffer is not already full. Similarly, before an entry is removed, the program doing the removing needs to ensure that that buffer is not already empty. A shared counter may be used to track the number of entries in the queue. The producer may increment the counter whenever an item is inserted, and the consumer may decrement the counter whenever an item is removed. A counter value of zero may indicate an empty queue, and a counter value equal to the size of the queue may indicate a full queue. Additional details concerning circular buffers may be obtained from the Internet at en.wikipedia.org/wiki/Circular_buffer.

A shared counter may work well in a processing system that use a single processor, but significant overhead may be incurred in a multi-processor system. Because the counter is read and written by both the producer processor and the consumer processor, memory coherence hardware in the processing system may need to transfer the counter back and forth frequently. The processors involved may stall waiting for the counter value to be transferred. The transfers may also use up scarce bus bandwidth, and may thus slow work being done on processors that are not involved with the task queue.

According to one conventional approach, the following operations are required per task execution: (a) the producer thread reads the counter before an insert; (b) if the queue is not full, the producer thread inserts the task data into the queue; (c) the producer thread increments the counter; (d) the consumer thread reads the counter before a removal; (e) if the queue is not empty, the consumer thread retrieves the task data from the queue; (f) the task is executed; (g) the consumer thread removes the task data from the queue; and (h) the consumer thread decrements the counter. Three or more bus transactions may be required for the above operations, not counting the task execution.

Other conventional approaches may compare the head and tail indices to determine whether the task queue is empty or full, but those approaches may also require three or more bus transactions per task execution.

### BRIEF DESCRIPTION OF THE DRAWINGS

Features and advantages of the present invention will become apparent from the appended claims, the following detailed description of one or more example embodiments, and the corresponding figures, in which:

FIG. 1 is a block diagram depicting a suitable data processing environment in which certain aspects of an example embodiment of the present invention may be implemented;

FIG. 2 is a flowchart of a process for creating and using a task queue according to an example embodiment of the present invention; and

FIG. 3 is a block diagram depicting a task queue according to an example embodiment of the present invention.

### DETAILED DESCRIPTION

Task queues in accordance with the present invention may operate more efficiently than conventional task queues. According to an example embodiment, each entry in the task queue includes a field that can be used to determine whether the queue is in an empty state or a full state. Consequently, the queue may be used without a shared counter, which may reduce the amount of time and bus bandwidth consumed.

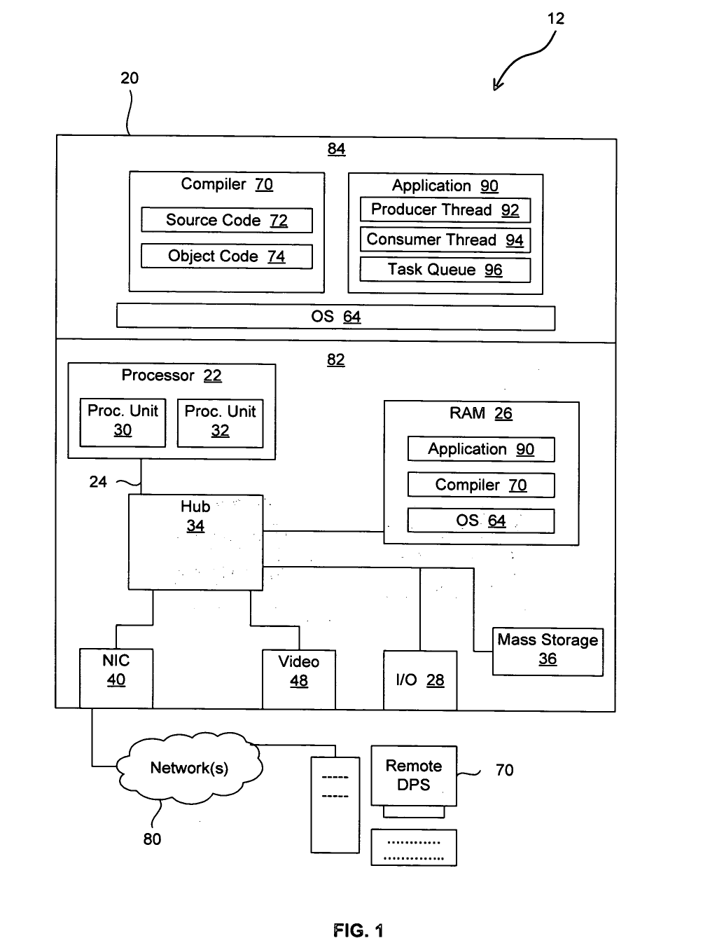

FIG. 1 is a block diagram depicting a suitable data processing environment 12 in which certain aspects of an example embodiment of the present invention may be implemented. Data processing environment 12 includes a processing system 20 that has various hardware components 82, such as a CPU 22 communicatively coupled to various other components via one or more system buses 24 or other communication pathways or mediums. This disclosure uses the term “bus” to refer to shared communication pathways, as well as point-to-point pathways. CPU 22 may include two or more processing units, such as processing unit 30 and processing unit 32. Alternatively, a processing system may include multiple processors, each having at least one processing unit. The processing units may be implemented as processing cores, as Hyper-Threading (HT) technology, or as any other suitable technology for executing multiple threads simultaneously or substantially simultaneously.

As used herein, the terms “processing system” and “data processing system” are intended to broadly encompass a single machine, or a system of communicatively coupled machines or devices operating together. Example processing systems include, without limitation, distributed computing systems, supercomputers, high-performance computing systems, computing clusters, mainframe computers, mini-computers, client-server systems, personal computers, workstations, servers, portable computers, laptop computers, tablets, telephones, personal digital assistants (PDAs), handheld devices, entertainment devices such as audio and/or video devices, and other devices for processing or transmitting information.

Processing system 20 may be controlled, at least in part, by input from conventional input devices, such as keyboards, mice, etc., and/or by directives received from another machine, biometric feedback, or other input sources or signals. Processing system 20 may utilize one or more connections to one or more remote data processing systems 70, such as through a network interface controller (NIC), a modem, or other communication ports or couplings. Processing systems may be interconnected by way of a physical and/or logical network 80, such as a local area network (LAN), a wide area network (WAN), an intranet, the Internet, etc. Communications involving network 80 may utilize various wired and/or wireless short range or long range carriers and protocols, including radio frequency (RF), satellite, microwave, Institute of Electrical and Electronics Engineers (IEEE) 802.11, 802.16, 802.20, Bluetooth, optical, infrared, cable, laser, etc. Protocols for 802.11 may also be referred to as wireless fidelity (WiFi) protocols. Protocols for 802.16 may also be referred to as WiMAX or wireless metropolitan area network protocols, and information concerning those protocols is currently available at grouper.ieee.org/groups/802/16/published.html.

Within processing system 20, processor 22 may be communicatively coupled to one or more volatile or non-volatile data storage devices, such as RAM 26, read-only memory (ROM), mass storage devices 36 such as integrated drive electronics (IDE) hard drives, and/or other devices or media, such as floppy disks, optical storage, tapes, flash memory, memory sticks, digital video disks, etc. For purposes of this disclosure, the term “ROM” may be used in general to refer to non-volatile memory devices such as erasable programmable ROM (EPROM), electrically erasable programmable ROM (EEPROM), flash ROM, flash memory, etc. Processor 22 may also be communicatively coupled to additional components, such as video controller 48, NIC 40, small computer system interface (SCSI) controllers, universal serial bus (USB) controllers, input/output (I/O) ports 28, input devices such as a keyboard and mouse, etc. Processing system 20 may also include one or more bridges or hubs 34 for communicatively coupling various system components.

Some components, such as video controller 48 for example, may be implemented as adapter cards with interfaces (e.g., a PCI connector) for communicating with a bus. In one embodiment, one or more devices may be implemented as embedded controllers, using components such as programmable or non-programmable logic devices or arrays, application-specific integrated circuits (ASICs), embedded computers, smart cards, and the like.

The invention may be described by reference to or in conjunction with associated data including instructions, functions, procedures, data structures, application programs, etc., which, when accessed by a machine, result in the machine performing tasks or defining abstract data types or low-level hardware contexts. Different sets of such data may be considered components of a software environment 84.

In the example embodiment, processing system 20 may load OS 64 into RAM 26 at boot time. Processing system 20 may also load a compiler 70 and/or one or more other applications 90 into RAM 26 for execution. Processing system 20 may obtain OS 64, compiler 70, and application 90 from any suitable local or remote device or devices.

Compiler 70 may be used to convert source code 72 into object code 74. Furthermore, when compiler 70 generates object code 74, compiler 70 may provide object code 74 with instructions that, when executed, implement a task queue according to the present invention, as well as associated producer and consumer tasks.

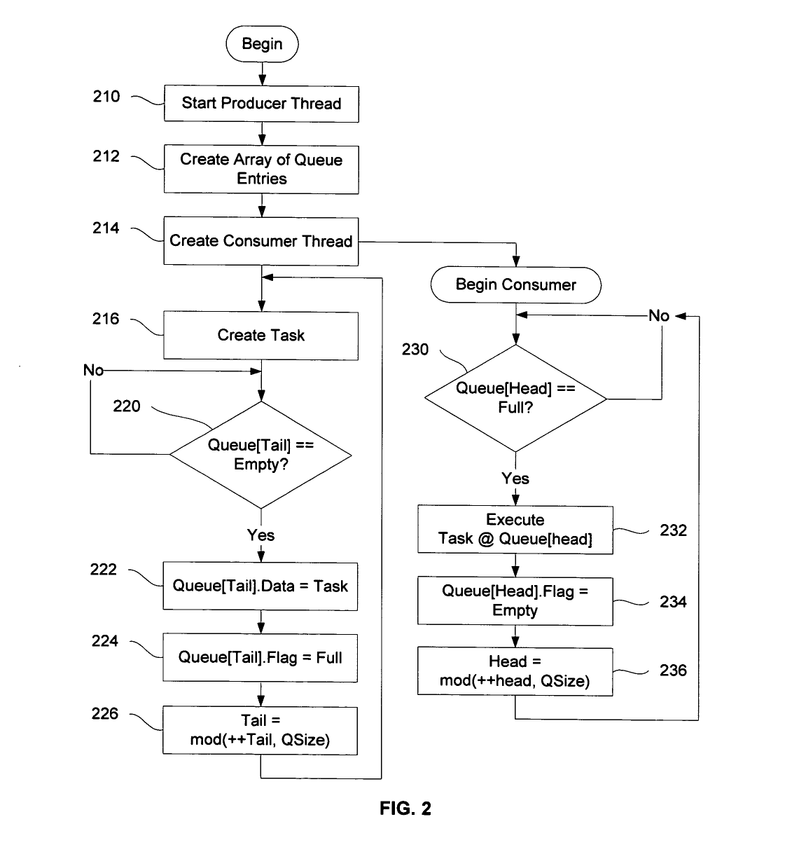

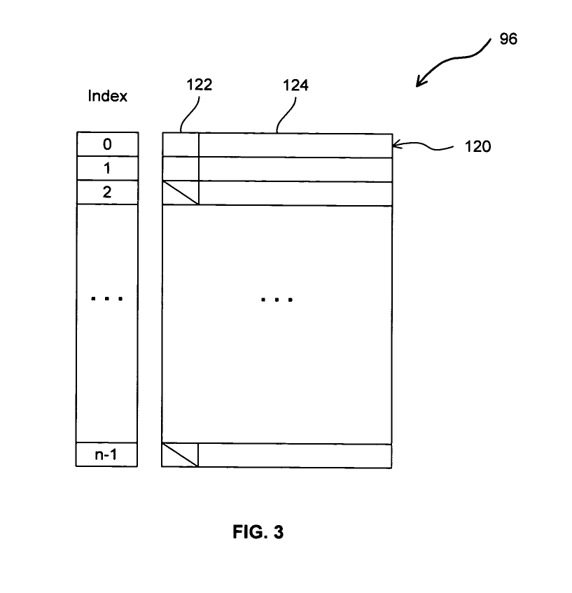

Application 90 may be based on object code that was generated by a compiler such as compiler 70. Accordingly, application 90 may include instructions which, when executed, implement a task queue 96 according to the present invention, as well as an associated producer task 92 and consumer task 94. In the example embodiment, producer task 92 and consumer task 94 track the empty and full states of task queue 96 in a distributed fashion, as described in greater detail below with regard to FIGS. 2 and 3.

Alternatively, a software developer may enter instructions for implementing a task queue when writing an application, or code for implementing a task queue may be included into an application from a library, for instance.

FIG. 2 is a flowchart of a process for creating and using a task queue according to an example embodiment of the present invention. The illustrated process may begin when application 90 is started, for example. Once application 90 is started, it may start a producer thread 92, as depicted at block 210. As shown at block 212, producer thread 92 then creates task queue 96 as an array of queue entries to operate as a circular buffer.

FIG. 3 is a block diagram depicting an example embodiment of a task queue 96. In the example embodiment, producer thread 92 creates task queue 96 with n entries or records 120, indexed from 0 to n-1. Thus task queue 96 has a size of n. In the example embodiment, each record 120 is the size of a cache line (e.g., 64 bytes), and is also cache line aligned. Each record 120 may include a status field 122 and a task field 124. Status field 122 is used to store a flag in each record that producer thread 92 and consumer thread 94 can use to determine whether that record is empty or full. Moreover, status field 122 also allows producer thread 92 and consumer thread 94 to determine whether task queue 96 is empty or full. Task field 124 is used to store data identifying a task to be executed. In the example embodiment, a single bit is used for status field 122, and the rest of the cache line beyond the flag bit may be used for the task data. The task data in task field 124 may include a function pointer and several function parameters, for example.

Referring again to FIG. 2, when producer thread 92 creates task queue 96, producer thread 92 initializes status field 122 in each record 120 to indicate an empty state (e.g., with a bit value of zero). After creating task queue 96, producer thread 92 may create consumer thread 94, as indicated at block 214. Producer thread 92 maintains an index to the tail of task queue 96, while consumer thread 94 maintains an index to the head (or front) of task queue 96. At initialization time, the head and tail indices are set to zero. Producer thread 92 and consumer thread 94 may then proceed to execute simultaneously or substantially simultaneously (e.g., in processing units 30 and 32, respectively).

As depicted at block 216, producer thread 92 may then create a task to be executed. Producer thread 92 may then determine whether or not there is room to add the task to task queue 96, as shown at block 220. In the example embodiment, producer thread 92 determines whether task queue 96 is already full by (a) retrieving the record pointed to by the tail index, and (b) checking the status field in that entry (e.g., queue[tail].flag==Empty?) to ensure that the entry is empty. If the tail entry is not empty, producer thread 92 may conclude that task queue 96 is full and may wait, as indicated by the arrow returning to block 220. Once the tail entry is empty, producer thread 92 inserts the task into task queue 96. In particular, producer thread 92 may place the task data into the task field of the tail entry, and producer thread 92 may update the status field of the tail entry to flag the tail entry as full, as indicated at blocks 222 and 224. As shown at block 226, producer thread 92 may then increment the tail index, possibly wrapping back to zero if the index is equal to the length of the buffer. The process may then return to block 216, with producer thread 92 creating additional tasks as necessary, and inserting those tasks into task queue 96 as described above. The tasks that are waiting in task queue 96 to be selected for execution may be referred to as pending tasks.

As shown at block 230, consumer thread 94 may begin by determining whether task queue 96 is empty. For instance, consumer thread 94 may (a) retrieve the record pointed to by the head index, and (b) check the status field in that entry (e.g., queue[head].flag==Full?). If the head record is empty, consumer thread 94 may conclude that task queue 96 is empty, and may wait, as indicated by the arrow returning to block 230. Once the head entry is full, consumer thread 94 may execute the task for that entry, based on the data in the task field in that entry, as shown at block 232. Upon completion of the task, consumer thread 94 removes the task from task queue 96. In particular, consumer thread 94 may set the status flag for the record to the empty state and increment the head index, possibly wrapping it around to zero, as indicated at blocks 234 and 236. The process may then return to block 230, with consumer thread 94 checking for another task to executed, as described above.

Because there is no centralized lock or counter that is being contended for, producer thread 92 and consumer thread 94 may stall only when necessary (i.e., when the queue is full or empty). In the example embodiment, producer thread 92 and consumer thread 94 do not need to read and update the same counter to use task queue 96. Also, because the status flag is contained within the same cache line as the task data, only a single bus transaction is required to transfer both the status data and the task data into producer thread 92 or consumer thread 94.

In one embodiment, a single producer and a single consumer use the task queue. For instance, the producer and consumer threads may use the task queue to provide for interaction with I/O devices, such as three-dimensional (3D) graphics cards or network devices, where the order of execution must match the order of issue. As another example, a single consumer task queue may be used to link the stages in pipeline style functional parallelism. An efficient task queue mechanism may be particularly important when dealing with small tasks (e.g., 3D graphics API calls), so that the overhead of inserting the tasks into the queue does not outweigh the benefits of parallel execution.

In light of the principles and example embodiments described and illustrated herein, it will be recognized that the illustrated embodiments can be modified in arrangement and detail without departing from such principles. Also, the foregoing discussion has focused on particular embodiments, but other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Similarly, although example processes have been described with regard to particular operations performed in a particular sequence, numerous modifications could be applied to those processes to derive numerous alternative embodiments of the present invention. For example, alternative embodiments may include processes that use fewer than all of the disclosed operations, processes that use additional operations, processes that use the same operations in a different sequence, and processes in which the individual operations disclosed herein are combined, subdivided, or otherwise altered.

Alternative embodiments of the invention also include machine accessible media encoding instructions for performing the operations of the invention. Such embodiments may also be referred to as program products. Such machine accessible media may include, without limitation, storage media such as floppy disks, hard disks, CD-ROMs, ROM, and RAM; and other detectable arrangements of particles manufactured or formed by a machine or device. Instructions may also be used in a distributed environment, and may be stored locally and/or remotely for access by single or multi-processor machines.

It should also be understood that the hardware and software components depicted herein represent functional elements that are reasonably self-contained so that each can be designed, constructed, or updated substantially independently of the others. In alternative embodiments, many of the components may be implemented as hardware, software, or combinations of hardware and software for providing the functionality described and illustrated herein.

In view of the wide variety of useful permutations that may be readily derived from the example embodiments described herein, this detailed description is intended to be illustrative only, and should not be taken as limiting the scope of the invention. What is claimed as the invention, therefore, is all implementations that come within the scope and spirit of the following claims and all equivalents to such implementations.

What is claimed is:

1. An apparatus comprising:
a machine-accessible medium; and
instructions in the machine-accessible medium, wherein the instructions, when executed by a processing system, cause the processing system to perform operations comprising:
creating a task queue to serve as a circular buffer, the task queue comprising records that each include a status field and a task field;
determining whether the task queue is full, based at least in part on the status field in a record at a tail of the task queue; and
adding a task to the task queue, in response to a determination that the status field in the record at the tail of the task queue marks that record as empty.

2. An apparatus according to claim 1, wherein the instructions in the machine-accessible medium comprise instructions which, when executed, cause the processing system to perform further operations comprising:
determining whether the task queue is empty, based at least in part on the status field in a record at a head of the task queue; and
causing the processing system to start executing a pending task identified by the task field in the record at the head of the task queue, in response to a determination that the status field in the record at the head of the task queue marks that record as full.

3. An apparatus according to claim 2, wherein the instructions in the machine-accessible medium comprise instructions which, when executed, cause the processing system to perform operations comprising:
executing a consumer thread that determines whether the task queue is empty, based at least in part on the status field in the record at the head of the task queue, before causing the processing system to start executing the pending task identified by the task field in the record at the head of the task queue.

4. An apparatus according to claim 3, wherein the consumer thread maintains a head index pointing to the record at the head of the task queue.

5. An apparatus according to claim 2, wherein the instructions in the machine-accessible medium comprise instructions which, when executed, cause the processing system to perform further operations comprising:
after causing the processing system to start executing the pending task identified by the task field in the record at the head of the task queue, removing the pending task from the task queue.

6. An apparatus according to claim 5, wherein the operation of removing the pending task from the task queue comprises updating the status field in the record at the head of the task queue to mark that record as empty.

7. An apparatus according to claim 1, wherein the instructions in the machine-accessible medium comprise instructions which, when executed, cause the processing system to perform further operations comprising:
after causing the processing system to add the task to the task queue, adjusting a tail index to point to a next record in the task queue.

8. An apparatus according to claim 1, wherein the instructions in the machine-accessible medium comprise instructions which, when executed, cause the processing system to perform operations comprising:
executing a producer thread that determines whether the task queue is full, based at least in part on the status field in the record at the tail of the task queue, before adding the task to the task queue.

9. An apparatus according to claim 8, wherein the producer thread maintains a tail index pointing to the record at the tail of the task queue.

10. A system comprising:
a task queue to serve as a circular buffer, the task queue comprising records that each include a status field and a task field; and
a producer thread to determine whether the task queue is full, based at least in part on the status field in a record at a tail of the task queue.

11. A system according to claim 10, further comprising:
the producer thread to add a task to the task queue, in response to a determination that the status field in the record at the tail of the task queue marks that record as empty.

12. A system according to claim 10, further comprising:
a consumer thread to determine whether the task queue is empty, based at least in part on the status field in a record at a head of the task queue.

13. A system according to claim 12, further comprising:
the consumer thread to cause a pending task identified by the record at the head of the task queue to start executing, in response to a determination that the status field in the record at the head of the task queue marks that record as full.

14. A method comprising:
creating a task queue to serve as a circular buffer for tasks to execute in a processing system, the task queue comprising records that each include a status field and a task field;
determining whether the task queue is full, based at least in part on the status field in a record at a tail of the task queue; and
adding a task to the task queue, in response to a determination that the status field in the record at the tail of the task queue marks that record as empty.

15. A method according to claim 14, further comprising:
determining whether the task queue is empty, based at least in part on the status field in a record at a head of the task queue; and
causing the processing system to start executing a pending task identified by the task field in the record at the head of the task queue, in response to a determination that the status field in the record at the head of the task queue marks that record as full.

16. A method according to claim 15, wherein the operations of determining whether the task queue is empty and causing the processing system to start executing the pending task are performed by a consumer thread.

17. A method according to claim 15, further comprising:
after causing the processing system to start executing the pending task, removing the pending task from the task queue.

18. A method according to claim 17, wherein the operation of removing the pending task from the task queue comprises updating the status field in the record at the head of the task queue to mark that record as empty.

19. A method according to claim 14, wherein the operations of determining whether the task queue is full and adding the task to the task queue are performed by a producer thread.

20. A method according to claim 14, further comprising:
after adding the task to the task queue, adjusting a tail index to point to a next record in the task queue.
